(19) United States
(12) Patent Application Publication
(10) Pub. No.: US 2026/0158307 A1
(43) Pub. Date: Jun. 11, 2026

(54) AUTONOMOUS AERIAL WILDFIRE DETECTION AND SUPPRESSION SYSTEM

(71) Applicants: Nino S. Levy, Ashdod (IL); Eitan Kenneth, Gan Yavne (IL)

(72) Inventors: Nino S. Levy, Ashdod (IL); Eitan Kenneth, Gan Yavne (IL)

(21) Appl. No.: 19/412,623

(22) Filed: Dec. 8, 2025

Related U.S. Application Data
(60) Provisional application No. 63/728,700, filed on Dec. 6, 2024.

(51) Int. Cl. A62C 3/02

(52) U.S. Cl. CPC A62C 3/0271; A62C 3/025

(57) ABSTRACT

The present disclosure provides a method for autonomous wildfire detection and suppression comprising continuously monitoring a vast geographic region using high altitude unmanned aerial vehicles equipped with long-wave infrared sensors, sensing each point within five minutes. The method comprises real-time processing of monitoring results to detect ignition signatures using sub-pixel radiometric processing and temporal analysis. Upon detecting ignition, the method executes fire extinguishing within a second period, where the sum of detection and suppression periods does not exceed fifteen to thirty minutes. Execution comprises launching a guided fire-suppression capsule from the unmanned aerial vehicle toward the ignition point, autonomously navigating the capsule, and autonomously delivering fire suppressant material to the ignition point.

### CROSS-REFERENCE TO RELATED APPLICATIONS

This application claims priority from U.S. Provisional Patent Application No. 63/728,700, filed Dec. 6, 2025, which is hereby incorporated by reference in its entirety.

### FIELD OF INVENTION

The present disclosure relates to autonomous aerial wildfire monitoring and suppression systems, and more particularly to high-altitude unmanned aerial vehicles equipped with infrared detection capabilities and guided fire-suppression capsules for rapid autonomous wildfire detection and extinguishment.

### BACKGROUND

Wildfires represent a growing global challenge, causing extensive ecological damage, economic losses, and threats to human safety. The frequency and intensity of wildfires have increased substantially in recent decades, driven by factors including climate change, extended drought conditions, and accumulated dry vegetation in fire-prone regions. The economic impact of wildfire suppression and damage has reached billions of dollars annually, with insurance carriers reporting catastrophic losses that have led to coverage withdrawals in high-risk areas.

Current wildfire detection methods rely primarily on satellite monitoring, ground-based lookout towers, and distributed sensor networks. Satellite-based detection systems provide broad coverage but suffer from temporal limitations due to orbital revisit intervals and may experience delays in data processing and transmission. Ground-based observation towers offer real-time monitoring capabilities but are limited by line-of-sight constraints, weather conditions, and the availability of trained personnel. Sensor networks deployed in wilderness areas can provide localized detection, but face challenges related to power supply, communication infrastructure, and environmental durability.

Existing aerial firefighting approaches typically employ manned aircraft operating at low altitudes to deliver water or fire retardant materials. These conventional methods face operational limitations including restricted flight capabilities during high wind conditions, reduced visibility from smoke, and atmospheric turbulence that can affect both aircraft safety and suppressant delivery accuracy. Wind drift and evaporation during descent can substantially reduce the effectiveness of suppressant materials, with ground-level concentrations often falling below optimal levels for fire suppression.

The effectiveness of wildfire suppression is closely tied to response time, as small ignitions can rapidly develop into large, uncontrollable fires under favorable weather conditions. Statistics indicate that while firefighting agencies successfully extinguish the majority of detected ignitions, a small percentage of fires that escape initial suppression efforts account for a disproportionate share of total wildfire damage. These escaped fires often occur in remote or mountainous terrain where access by ground crews is limited and aerial response may be delayed.

There exists a general need for improved wildfire detection and suppression systems that can provide rapid response capabilities, operate effectively under adverse weather conditions, and deliver suppressant materials with enhanced precision to maximize suppression effectiveness while minimizing environmental impact.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for autonomous wildfire detection and suppression is provided. The method comprises continuously monitoring a vast geographic region to generate monitoring results, using high altitude unmanned aerial vehicles that are equipped with long-wave infrared sensors such that each point within the region is sensed within a first period that does not exceed about five minutes. The method comprises processing in real time and by a computerized system, the monitoring results to detect an ignition signature at an ignition point, using sub-pixel radiometric processing and temporal analysis. The method comprises when finding the ignition signature, executing a fire extinguishing process that is completed within a second period, wherein a duration of a sum of the first period and the second period does not exceed a defined value between fifteen and thirty minutes. The executing comprises launching by a given high-altitude unmanned aerial vehicle, a guided fire-suppression capsule toward the ignition point. The executing comprises autonomously navigating the guided fire-suppression capsule towards the ignition point. The executing comprises autonomously delivering, by the guided fire-suppression capsule, a fire suppressant material to the ignition point. Executing the monitoring and the fire extinguishing process by the same high altitude unmanned aerial vehicles reduces the response time.

According to other aspects of the present disclosure, the method may include one or more of the following features. The autonomously navigating may be executed while the guided fire-suppression capsule descends at supersonic or near supersonic speed through atmospheric wind layers to minimize wind drift during descent. The capsule achieves supersonic or near supersonic speed due to gravitational acceleration from high altitude release (high altitude launching) and/or its low drag aerodynamic profile. The autonomous delivery may comprise releasing the fire suppressant material at an altitude above ground level determined based on measured wind speed conditions. The releasing may be preceded by atomizing the fire suppressant material before the releasing. For a measured wind that does not exceed ten kilometers per hour, the altitude may be about one hundred feet, wherein for a measured wind that ranges between ten and forty kilometers per hour the altitude may be about fifty feet, and wherein for a measured wind that is above fifty kilometer per hour the altitude may be about thirty feet. The continuously monitoring may be executed by the high altitude unmanned aerial vehicles while flying at an altitude that ranges between thirty thousand and fifty thousand feet. The continuously monitoring may be executed by the high altitude unmanned aerial vehicles while flying at a turbulence free air region where wind shear is below 2 m/s. The launching may be executed at an altitude that ranges between thirty thousand and fifty thousand feet. The executing may comprise selecting the given high-altitude unmanned aerial vehicle based on a proximity of the high-altitude unmanned aerial vehicles to the ignition point. The selecting may be executed by the high-altitude unmanned aerial vehicles. The selecting may be further based on an availability of guided fire-suppression capsules. The method may further comprise receiving coordinates of the ignition point by the guided fire-suppression capsule, wherein the navigating is based on the coordinates and on infrared sensing of fire at the ignition point. The coordinates may be provided to the guided fire-suppression capsule by the given high-altitude unmanned aerial vehicle. The method may further comprise checking whether the fire extinguishing process succeeded and performing another fire extinguishing process when the fire extinguishing process succeeded failed. The executing a fire extinguishing process may be further conditioned by receiving a human approval.

According to another aspect of the present disclosure, a guided fire-suppression capsule for autonomous wildfire suppression is provided. The guided fire-suppression capsule comprises an aerodynamic body configured for deployment from a high-altitude unmanned aerial vehicle. The guided fire-suppression capsule comprises an infrared seeker positioned in a forward section of the body and configured to acquire thermal signatures of fires. The guided fire-suppression capsule comprises a GPS/INS navigation module configured to provide positioning data during flight. The guided fire-suppression capsule comprises flight-control electronics configured to process guidance signals. The guided fire-suppression capsule comprises a suppressant reservoir containing fire suppressant material. The guided fire-suppression capsule comprises a dispersion mechanism configured to atomize and release the fire suppressant material at a predetermined altitude to achieve effective ground coverage, wherein the guided fire-suppression capsule is configured to autonomously navigate to a wildfire ignition point with high accuracy-for example-up to 10 meter Circular Error Probability (CEP).

According to other aspects of the present disclosure, the guided fire-suppression capsule may include one or more of the following features. The dispersion mechanism may comprise solenoid valves and a pressurization system configured to atomize the fire suppressant material into droplets. The fire suppressant material may comprise at least one material selected from the group consisting of ammonium phosphate, gel, foam, powder, water, liquid nitrogen, inert gases, carbon dioxide, and argon.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a diagram of an unmanned aerial vehicle for systematic area coverage.

FIG. 2 depicts a lawn-mower flight pattern used by an unmanned aerial vehicle for systematic area coverage, according to an embodiment.

FIG. 3 illustrates a schematic diagram of the geometry and operational parameters of a long-wave infrared detection system, according to aspects of the present disclosure.

FIG. 4 depicts a side view of a guided fire-suppression capsule, according to an embodiment.

FIG. 5 illustrates a guidance mechanism for the guided fire-suppression capsule of FIG. 4, according to aspects of the present disclosure.

FIG. 6 depicts a system architecture diagram for an autonomous wildfire detection and suppression system, according to an embodiment.

FIG. 7 illustrates a sequence diagram representing an end-to-end wildfire suppression timeline, according to aspects of the present disclosure.

FIG. 8 depicts a block diagram of a dispersion mechanism for the guided fire-suppression capsule, according to an embodiment.

FIG. 9 a diagram of an integrated wildfire detection and suppression system, according to aspects of the present disclosure.

FIG. 10 is a diagram of an integrated wildfire detection and suppression system, according to aspects of the present disclosure.

FIG. 11 illustrates an example of a method.

FIG. 12 illustrates an example of a method.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

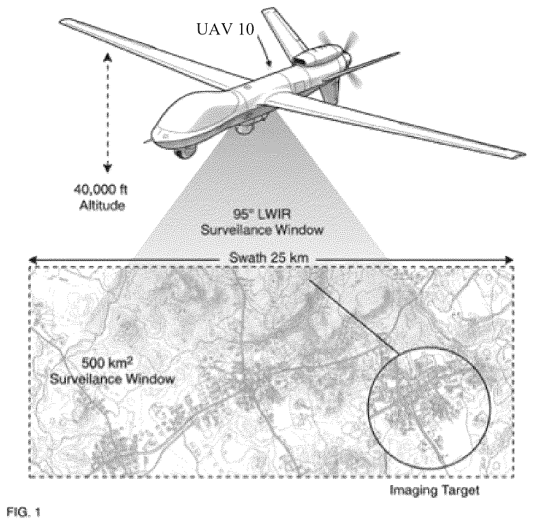

Referring to FIG. 1, the high-altitude unmanned aerial 10 flying at an elevation (for example) of 40,000 feet using LWIR sensors having an angular coverage of (for example) ninety degrees along to transverse axis having a field of view having a swath of (for example) 25 kilometers.

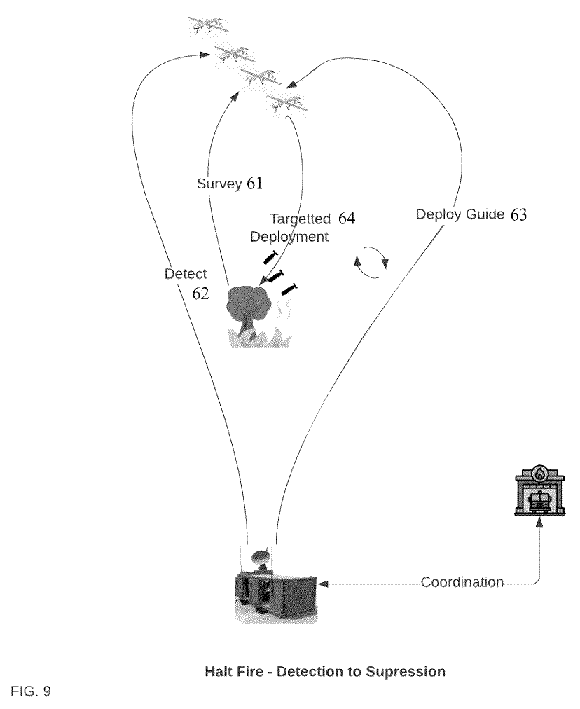

Referring to FIG. 9, a system for autonomous wildfire detection and suppression may include a ground command and control station that communicates with multiple system components to enable rapid fire detection and suppression capabilities. The ground command and control station may establish communication links with a fleet of high-altitude unmanned aerial vehicles, a local fire department, and external ignition surveillance systems such as satellite-based fire detection services. Each unmanned aerial vehicle in the fleet may be equipped with long-wave infrared sensors for detecting thermal signatures of ignitions and may carry multiple guided fire-suppression capsules for deployment upon detection of a wildfire ignition.

The fleet of high-altitude unmanned aerial vehicles may continuously monitor a vast geographic region to generate monitoring results, with each point within the region being sensed within a first period that does not exceed about five minutes. The ground command and control station may process the monitoring results in real time using a computerized system to detect ignition signatures at ignition points through sub-pixel radiometric processing and temporal analysis. When an ignition signature is found, the system may execute a fire extinguishing process that is completed within a second period, wherein a duration of a sum of the first period and the second period does not exceed a defined value between fifteen and thirty minutes.

As shown in FIG. 9, the system may include a command and control subsystem configured to maintain continuous monitoring during red-flag fire weather conditions and to authorize deployment of guided fire-suppression capsules. The command and control subsystem may receive red flag alerts and coordinate the deployment and operation of the unmanned aerial vehicles across designated fire-prone regions. The system may integrate with external data feeds including fire-department and satellite data feeds and red flag alerts for atmospheric conditions favorable to ignition, providing supplementary detection data to enhance overall situational awareness and detection capability across the monitored area.

The system may operate with fleet sizes of 4 to 8 unmanned aerial vehicles, with each unmanned aerial vehicle carrying 4 to 6 guided fire-suppression capsules for extended coverage during red-flag periods. Communication links may be established between the ground command and control station and each of the unmanned aerial vehicles to enable real-time data transmission, command issuance, and coordination of surveillance patterns over designated fire-prone regions. The fleet sizing may provide sufficient coverage for re-ignition scenarios and may enable rotation of unmanned aerial vehicles to maintain continuous coverage during extended red-flag periods, which may typically span 48 hours.

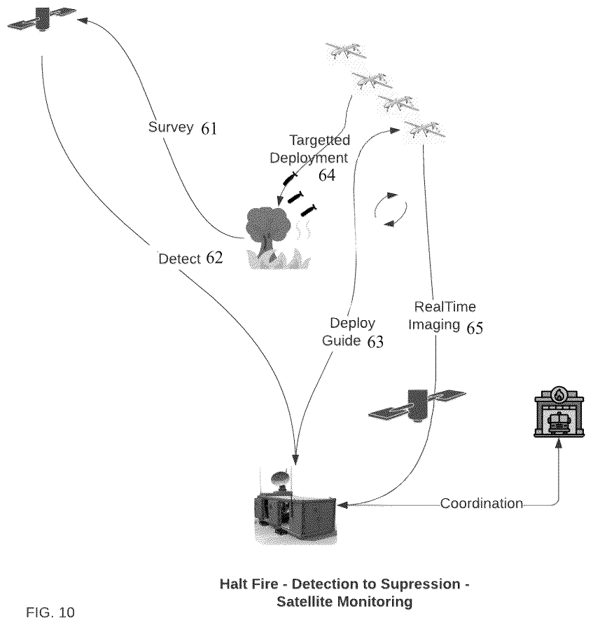

Referring to FIG. 10, the system for autonomous wildfire detection and suppression may also include one or more satellites for monitoring the field of view—instead or in addition to the high altitude unmanned aerial vehicles.

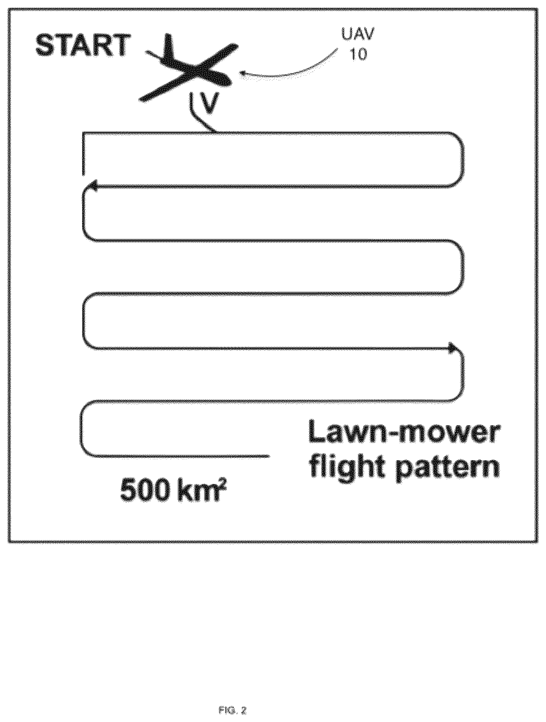

Referring to FIG. 2, the high-altitude unmanned aerial vehicles may execute a boustrophedon lawn-mower flight pattern for systematic area coverage during the continuous monitoring process. The flight pattern may show a back-and-forth scanning trajectory starting from a marked start position, with the aircraft following parallel horizontal legs connected by 180-degree turns at the boundaries of the monitored region. This serpentine pattern may provide complete coverage of the designated area and may enable each point within the surveillance window to be sensed within a first period that does not exceed about five minutes.

The surveillance window may encompass approximately 500 square kilometers, as the boustrophedon pattern may allow for efficient and comprehensive monitoring of vast geographic regions. The high-altitude unmanned aerial vehicles may fly at altitudes ranging between thirty thousand and fifty thousand feet during the continuous monitoring operations. At these altitudes, the unmanned aerial vehicles may operate in turbulence-free air regions, which may maintain effective surveillance capabilities and may provide stable platform conditions for the long-wave infrared sensors.

The flight pattern may consist of parallel horizontal legs that may be systematically traversed to ensure no areas within the monitored region are missed during surveillance operations. The 180-degree turns at the boundaries may allow the unmanned aerial vehicles to transition between adjacent surveillance legs while maintaining continuous coverage. The timing and spacing of the flight legs may be configured such that the entire geographic region may be scanned within the specified time period, enabling rapid detection of ignition signatures.

Alternative flight patterns may be employed depending on terrain characteristics, regional requirements, or operational constraints. The unmanned aerial vehicles may execute racetrack patterns, which may involve oval or circular flight paths that may provide repeated coverage of specific high-risk areas. Spiral patterns may also be utilized, wherein the unmanned aerial vehicles may follow expanding or contracting circular trajectories to cover designated regions. Coordinated overlapping patterns may be implemented using multiple unmanned aerial vehicles, wherein the flight paths may be synchronized to provide redundant coverage and may reduce the time intervals between successive observations of any given point within the monitored area.

The selection of flight patterns may depend on factors such as the size and shape of the monitored region, the number of available unmanned aerial vehicles in the fleet, weather conditions, and the specific surveillance requirements for different geographic areas. The flight patterns may be pre-programmed or may be dynamically adjusted based on real-time conditions and detection results to optimize coverage and response capabilities.

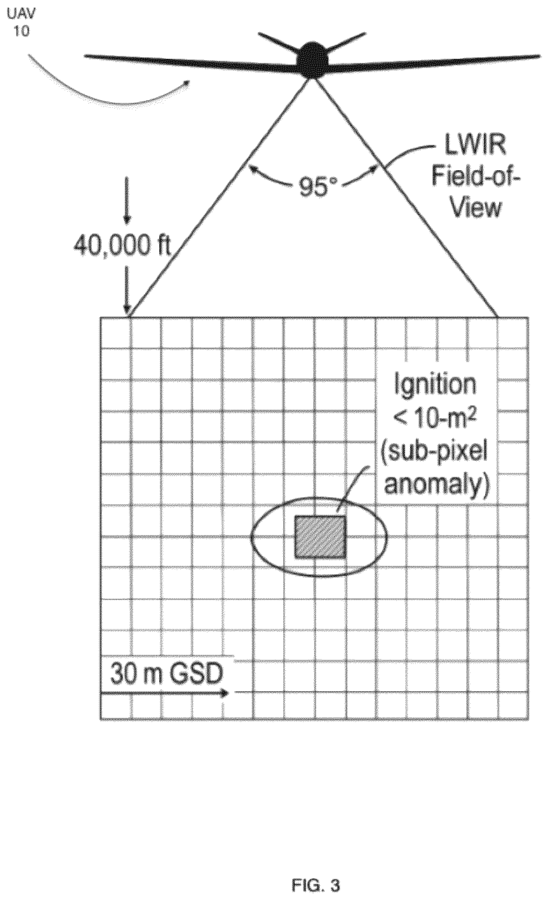

Referring to FIG. 3, the long-wave infrared detection system may employ a specific imaging geometry to enable detection of small ignition signatures across vast geographic areas. A high-altitude unmanned aerial vehicle positioned at an altitude of 40,000 feet may direct a long-wave infrared sensor with a 95-degree field-of-view toward the ground surface below. The sensor may provide ground coverage exceeding 25 kilometers in width, with two lines extending downward from the unmanned aerial vehicle defining the angular coverage cone of the sensor.

The long-wave infrared sensor may generate thermal imagery with a ground sample distance of approximately 30 meters, as depicted by the gridded representation in FIG. 3. The ground area may be represented as a rectangular matrix of cells, wherein each cell corresponds to a 30-meter ground sample distance unit. This imaging geometry may enable the detection system to monitor large geographic areas while maintaining sufficient spatial resolution for identifying thermal anomalies associated with wildfire ignitions.

A computerized system may process the monitoring results in real time to detect an ignition signature at an ignition point using sub-pixel radiometric processing and temporal analysis. The sub-pixel radiometric processing may enable identification of ignition areas of approximately ten square meters or larger within individual pixels or small clusters of pixels in the thermal imagery. As shown in FIG. 3, a small shaded region may represent an ignition area of less than 10 square meters, which may appear as a sub-pixel anomaly within the thermal imagery despite being smaller than the 30-meter ground sample distance.

The sub-pixel radiometric processing may analyze thermal intensity variations within individual pixels to identify temperature anomalies that may indicate the presence of fire signatures. The temporal analysis component may compare successive thermal images over time to identify newly appearing thermal anomalies or changes in thermal signature patterns that may correspond to ignition events. The combination of sub-pixel radiometric processing and temporal analysis may enable the detection system to identify ignition signatures that may occupy areas smaller than the nominal ground sample distance of the imaging system.

The detection system may employ alternative multi-spectral sensors in addition to long-wave infrared sensors to enhance detection capabilities under various atmospheric conditions. Mid-wave infrared sensors may be utilized to provide thermal detection capabilities in different spectral bands, which may offer improved performance under certain atmospheric conditions or for specific types of fire signatures. Short-wave infrared sensors may be employed to detect thermal signatures in shorter wavelength bands, which may provide complementary detection capabilities to the long-wave infrared sensors.

Visible-light sensors may also be integrated into the detection system to provide additional spectral information for ignition detection and validation. The visible-light sensors may enable detection of smoke plumes or visual indicators of fire activity that may complement the thermal detection capabilities of the infrared sensors. The combination of multiple sensor types may provide enhanced detection reliability and may enable the system to operate effectively under varying atmospheric conditions, including conditions with smoke, haze, or other atmospheric obscurants that may affect individual sensor performance.

The multi-spectral approach may allow the detection system to adapt to different environmental conditions and fire types by selecting the most appropriate sensor modality or by fusing data from multiple sensors to improve detection accuracy and reduce false alarm rates. The computerized system may process data from multiple sensor types simultaneously to provide comprehensive thermal and optical analysis of the monitored geographic regions.

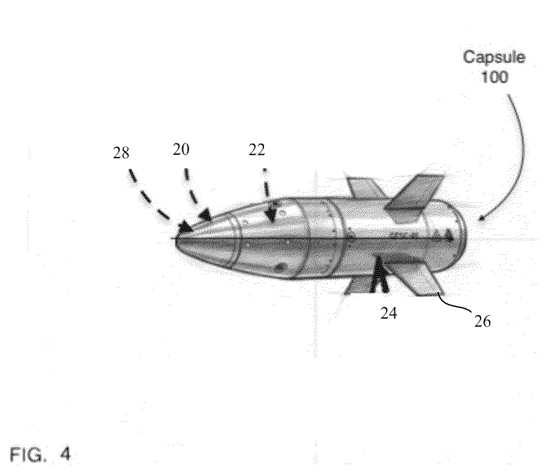

Referring to FIG. 4, a guided fire-suppression capsule 100 for autonomous wildfire suppression may include an aerodynamic body configured for deployment from a high-altitude unmanned aerial vehicle. The aerodynamic body may exhibit a cylindrical configuration with a tapered nose cone at a forward end and fins 26 at an aft end to provide aerodynamic stability during descent. The capsule may be designed for aerial deployment from unmanned aerial vehicle hardpoints and may incorporate guidance, navigation, and control systems to enable autonomous flight to a designated target location. The nose cone may be coated with polymer 28.

The guided fire-suppression capsule may include an infrared sensor 20 positioned in a forward section of the body and configured to acquire thermal signatures of fires. As shown in FIG. 4, the infrared sensor may be positioned near the forward section of the capsule to enable detection and tracking of thermal signatures associated with wildfire ignitions. The infrared sensor may provide targeting data during terminal guidance phases to enable precise navigation to ignition points.

A GPS/INS navigation module 22 may be configured to provide positioning data during flight, as depicted in the mid-body region of the capsule in FIG. 4. The GPS/INS navigation module 22 may enable the guided fire-suppression capsule to receive and process location coordinates for navigation to designated ignition points. The navigation module may provide positioning information throughout the flight trajectory to support autonomous navigation capabilities.

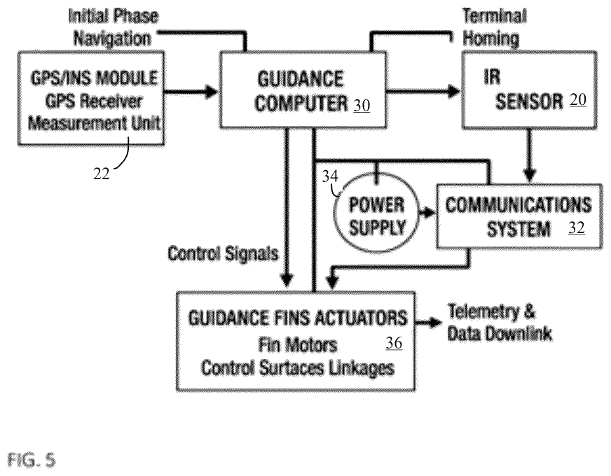

The guided fire-suppression capsule may include flight-control electronics (such as guidance computer 30 of FIG. 5) configured to process guidance signals from the infrared sensor and the GPS/INS navigation module. The flight-control electronics may generate control commands for trajectory adjustment and may coordinate the operation of guidance systems throughout the capsule's flight. The flight-control electronics may process sensor feedback and may generate appropriate control responses to maintain accurate flight paths toward target locations.

As further shown in FIG. 4, the guided fire-suppression capsule may include deployable control surfaces (such as fins 26) driven by actuators controlled by the flight-control electronics to adjust trajectory in response to sensor feedback. The fins at the aft end may serve as control surfaces that may be actuated to provide steering and trajectory correction capabilities. The actuators may respond to commands from the flight-control electronics to adjust the orientation and flight path of the capsule during descent and terminal guidance phases.

A suppressant reservoir containing fire suppressant material 24 may be located in the aft portion of the capsule, as illustrated in FIG. 4. The suppressant reservoir may store fire-extinguishing materials that may be dispensed upon reaching the target ignition area. The fire suppressant material may comprise at least one material selected from the group consisting of ammonium phosphate, gel, foam, powder, water, liquid nitrogen, inert gases, carbon dioxide, and argon. The selection of suppressant material may depend on the specific fire conditions, environmental factors, and operational requirements for each deployment scenario. Different fire suppressant materials may be released in different manner using different dispersion means.

The guided fire-suppression capsule may include a dispersion mechanism configured to atomize and release the fire suppressant material at a predetermined altitude to achieve effective ground coverage. As shown in FIG. 4, a burst actuator may be positioned within the capsule to control the release of suppressant material. The dispersion mechanism may include a range finder or altimeter that may determine the appropriate altitude for suppressant release based on atmospheric conditions and target area characteristics.

The capsule construction may withstand high-altitude environmental conditions including temperatures from −40° C. to +50° C., pressures down to 300 mbar, aerodynamic loads up to 10 g, and thermal exposure up to 200° C. externally. The exterior surface may include infrared-grade polymer material at the nose section to provide thermal protection and may maintain structural integrity during exposure to extreme environmental conditions. The capsule may be engineered to maintain operational functionality throughout the deployment process, from high-altitude release through terminal engagement with fire targets.

The guided fire-suppression capsule may be configured to autonomously navigate to a wildfire ignition point with high accuracy through the integration of the infrared seeker, GPS/INS navigation module, flight-control electronics, and deployable control surfaces. The combination of these systems may enable the capsule to achieve precise targeting and may deliver suppressant material directly to ignition areas with minimal deviation from intended impact points.

Referring to FIG. 5, a guidance mechanism for a guided fire-suppression capsule may enable autonomous navigation towards an ignition point through a coordinated system of sensors, processors, and control actuators (see guidance fins actuators, fin motors 36 and control surface linkage collectively denoted 36). The guidance mechanism may operate through two distinct phases: an initial phase for navigation and a terminal phase for homing to the target location. During the initial phase, a GPS/INS module 22 comprising a GPS receiver and measurement unit may provide positioning data to a guidance computer 30 for trajectory control.

The guided fire-suppression capsule may receive coordinates of the ignition point provided by a given high-altitude unmanned aerial vehicle, wherein the navigating may be based on the coordinates and on infrared sensing (by infrared sensor 20) of fire at the ignition point. The coordinates may be transmitted from the high-altitude unmanned aerial vehicle to the guided fire-suppression capsule through communication systems (such as communication system 32) that may enable real-time data transfer during deployment operations. The guidance computer may process the received coordinates and may generate control signals for initial trajectory guidance toward the designated target area.

As shown in FIG. 5, the GPS/INS module may include a GPS receiver that may obtain satellite positioning data and a measurement unit that may provide inertial navigation capabilities. The GPS receiver may process satellite signals to determine the current position of the guided fire-suppression capsule during flight, while the measurement unit may provide acceleration and angular velocity data for inertial navigation calculations. The combination of GPS and inertial navigation systems may enable continuous position tracking even in environments where satellite signals may be temporarily obscured or degraded.

The guidance computer may serve as a central processing unit that may coordinate the operation of multiple guidance subsystems throughout the capsule's flight trajectory. During the initial phase, the guidance computer may process positioning data from the GPS/INS module and may calculate trajectory corrections needed to navigate toward the target coordinates. The guidance computer may generate control signals that may be sent to guidance fins actuators for trajectory adjustment and course correction.

The guidance fins actuators may include fin motors and control surfaces linkages that may provide physical control over the capsule's flight path, as illustrated in FIG. 5. The fin motors may receive control signals from the guidance computer and may actuate control surfaces to adjust the aerodynamic forces acting on the capsule. The control surfaces linkages may mechanically connect the fin motors to deployable control surfaces, enabling precise adjustment of the capsule's orientation and trajectory during descent.

During the terminal phase, an infrared homing sensor may acquire thermal signatures of fires and may provide targeting data to the guidance computer for final approach guidance. The infrared homing sensor may detect thermal emissions from the ignition point and may enable the guidance computer to refine the capsule's trajectory for precise targeting. The guidance computer may continue to send control signals to the guidance fins actuators for trajectory correction based on both GPS positioning data and infrared sensor feedback.

A power supply may provide electrical power to the guidance computer, which may in turn power a communications system that may interface with both the infrared homing sensor and the guidance fins actuators. The communications system may enable telemetry and data downlink throughout the capsule's flight, allowing for monitoring of guidance system performance and trajectory status. The power supply may maintain electrical power to all guidance subsystems throughout the deployment process from release to target engagement.

The guided fire-suppression capsule may employ alternative guidance systems that may include electro-optical cameras in addition to infrared seekers for enhanced target acquisition capabilities. Electro-optical cameras may provide visible-light imaging that may complement infrared detection and may enable target identification under varying atmospheric conditions. The electro-optical cameras may operate in conjunction with infrared sensors to provide multi-spectral target acquisition and may improve guidance accuracy through sensor fusion techniques.

Laser-assisted guidance systems may be integrated into the guided fire-suppression capsule to provide additional targeting capabilities beyond infrared and electro-optical sensors. Laser-assisted guidance may employ laser range finding or laser designation techniques to enhance target location accuracy and may provide precise distance measurements to target areas. The laser-assisted guidance systems may operate in coordination with other sensor modalities to provide comprehensive targeting information for terminal guidance operations.

The guided fire-suppression capsule may utilize GPS-only navigation without infrared guidance components in scenarios where thermal targeting may not be feasible or where simplified guidance systems may be preferred. GPS-only navigation may rely exclusively on satellite positioning data and may navigate to predetermined coordinates without requiring thermal sensor feedback. This approach may provide cost-effective guidance capabilities and may be suitable for deployment scenarios where target coordinates are precisely known and thermal guidance may not be necessary.

The guidance system may employ open-source hybrid systems using Drone Kit or ArduPilot-based frameworks integrated with Raspberry Pi controllers for flight control processing. The Raspberry Pi controllers may serve as the primary guidance computer and may execute open-source flight control software to manage navigation and trajectory control functions. The ArduPilot-based frameworks may provide established flight control algorithms and may enable rapid development and deployment of guidance capabilities using proven software architectures.

The guided fire-suppression capsule may include specific component implementations such as an MPU-6050 inertial measurement unit that may provide 6-axis gyroscope and accelerometer data for inertial navigation and stability control. The MPU-6050 may generate angular velocity and linear acceleration measurements that may be processed by the guidance computer to determine capsule orientation and motion characteristics. The inertial measurement unit data may be integrated with GPS positioning information to provide comprehensive navigation capabilities throughout the flight trajectory.

A u-blox NEO-M8N GPS module may serve as the primary GPS receiver for satellite positioning during the initial navigation phase. The u-blox NEO-M8N may provide high-accuracy positioning data and may support various GPS enhancement techniques to improve location accuracy. The GPS module may interface with the guidance computer to provide real-time position updates that may enable precise navigation toward target coordinates.

A BMP388 barometric sensor may function as an altimeter to provide altitude measurements for altitude-dependent guidance decisions and suppressant release timing. The BMP388 may measure atmospheric pressure and may calculate altitude above sea level or above ground level depending on calibration settings. The barometric sensor data may be used by the guidance computer to determine appropriate altitudes for guidance phase transitions and for triggering suppressant dispersion mechanisms.

Hitec HS-645MG servos may be employed for control surfaces actuation, providing the mechanical interface between the guidance computer and the deployable control surfaces. The Hitec HS-645MG servos may receive control signals from the guidance computer and may position control surfaces to achieve desired aerodynamic control forces. The servos may provide precise angular positioning of control surfaces and may enable rapid response to guidance commands for effective trajectory control throughout the capsule's descent and terminal approach phases.

Referring to FIG. 9, a system architecture for autonomous wildfire detection and suppression may include a ground control station that may serve as a central coordination hub for operational flow and decision-making processes. The ground control station may establish bidirectional communication channels with multiple system components to enable comprehensive wildfire monitoring and response capabilities. The system architecture may facilitate coordinated operations between unmanned aerial vehicles, fire department personnel, and external surveillance systems through structured communication pathways and operational protocols. See the following steps—survey 61 (part of the monitoring), detect 62 (detection of a wildfire), deploy guide 63 (instructions regarding the fire extinguishing process) and targeted deployment 64.

The ground control station may communicate with a fire department through a bidirectional communication channel that may enable real-time information sharing and coordination of suppression activities. The communication pathway between the ground control station and the fire department may allow for transmission of ignition detection data, deployment status updates, and coordination of ground-based firefighting resources. The fire department may provide feedback to the ground control station regarding ground conditions, access routes, and additional resource requirements that may influence aerial suppression operations.

As shown in FIG. 9, the ground control station may establish communication links with multiple high-altitude unmanned aerial vehicles that may be deployed in airspace above a monitored region. The communication links may enable the ground control station to receive monitoring results from the unmanned aerial vehicles and may transmit deployment commands and target coordinates to the fleet. The ground control station may coordinate the selection of unmanned aerial vehicles for guided fire-suppression capsule deployment based on proximity to ignition points and availability of suppressant payloads.

The method for autonomous wildfire detection and suppression may include executing a fire extinguishing process that may be further conditioned by receiving a human approval before deployment of guided fire-suppression capsules. The ground control station may present ignition detection data to human operators who may evaluate the detection results and may authorize or deny deployment of guided fire-suppression capsules based on operational considerations. The human approval process may include assessment of ignition location, weather conditions, aircraft traffic, and potential risks to personnel or property in the target area.

The human approval process may involve display of thermal imagery, geographic coordinates, and situational awareness data to enable informed decision-making by human operators. The operators may review detection confidence levels, atmospheric conditions, and availability of alternative suppression resources before authorizing autonomous deployment of guided fire-suppression capsules. The approval process may include verification of target coordinates and confirmation that the detected ignition signature corresponds to an actual wildfire rather than a false alarm or non-fire thermal source.

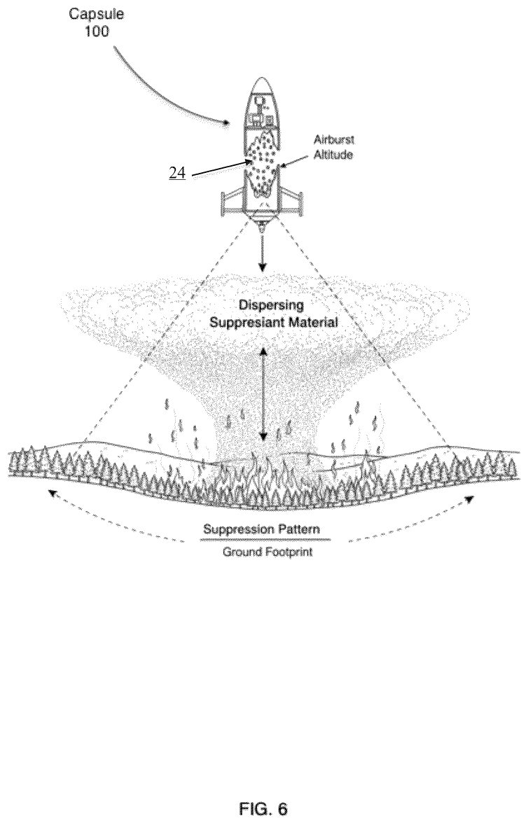

The ground control station may receive data from external ignition surveillance systems, including satellite-based fire detection platforms, as illustrated in FIG. 6. The external surveillance systems may provide supplementary detection data that may be integrated with unmanned aerial vehicle sensor data to enhance overall situational awareness and detection reliability. The integration of multiple data sources may enable cross-validation of ignition detections and may reduce false alarm rates through corroborating evidence from independent sensor systems. An example of one or more satellites is illustrated in FIG. 10 where the monitoring is executed at least in part by the one or more satellites and the high altitude UAVs execute the deployment. Both high altitude UAVs and the one or more satellites may participate in method 200. FIG. 9 also illustrates step 65 of real time imaging 65.

The method for autonomous wildfire detection and suppression may further include checking whether the fire extinguishing process succeeded and performing another fire extinguishing process when the fire extinguishing process failed. The ground control station may coordinate post-deployment assessment activities to determine the effectiveness of guided fire-suppression capsule deployments. The assessment process may involve continued monitoring of target areas using unmanned aerial vehicle sensors to evaluate thermal signature changes following suppressant delivery.

The checking process may include analysis of thermal imagery captured after guided fire-suppression capsule deployment to determine whether ignition signatures have been eliminated or reduced below predetermined thresholds. The ground control station may compare pre-deployment and post-deployment thermal signatures to assess the effectiveness of suppressant delivery and may identify areas where additional suppression efforts may be needed. The thermal analysis may account for expected cooling times and may distinguish between successful suppression and temporary thermal masking effects.

When the fire extinguishing process is determined to have failed, the method may include performing another fire extinguishing process through deployment of additional guided fire-suppression capsules from available unmanned aerial vehicles. The ground control station may coordinate sequential deployments of multiple guided fire-suppression capsules to build up suppressant coverage over areas surrounding ignition points. The sequential deployment process may involve selection of different unmanned aerial vehicles or adjustment of targeting coordinates to address areas that may not have received adequate suppressant coverage during initial deployment attempts.

The ground control station may maintain communication with unmanned aerial vehicles throughout multiple deployment cycles to coordinate repeated suppression attempts and may track the availability of guided fire-suppression capsules across the fleet. The system may prioritize deployment of additional capsules based on fire growth patterns, weather conditions, and strategic considerations for containing fire spread. The repeated deployment capability may enable the system to address re-ignition events or to provide additional suppressant coverage for fires that may not be fully extinguished by initial deployment attempts.

The communication pathways between system components may enable real-time coordination of assessment and redeployment activities through continuous data exchange between the ground control station, unmanned aerial vehicles, and fire department personnel. The integrated communication architecture may support rapid decision-making for follow-up suppression actions and may enable coordination with ground-based firefighting resources when aerial suppression efforts may require supplementation with conventional firefighting techniques.

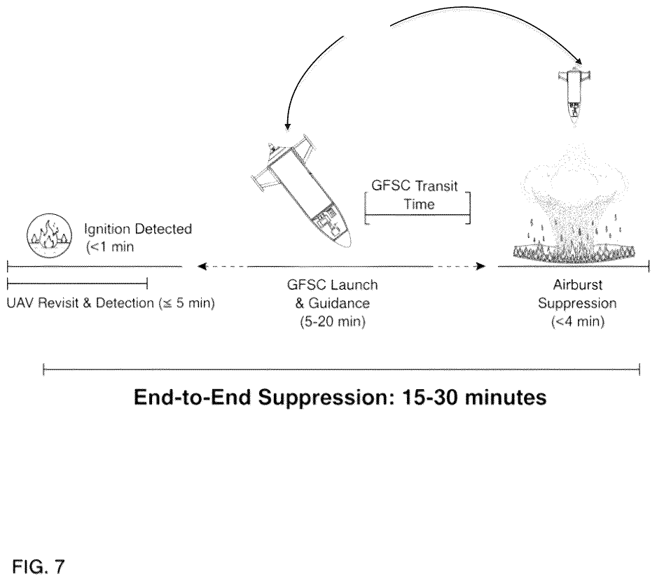

Referring to FIG. 7, an end-to-end suppression timeline may illustrate the temporal sequence from initial ignition detection through complete suppressant delivery, demonstrating how the fire extinguishing process may be completed within defined time parameters. The timeline may span approximately 15-30 minutes from initial ignition detection to complete airburst suppression, with the sequence beginning with UAV revisit and detection phases shown on the left side of the diagram. The ignition may be detected within less than one minute during the UAV revisit phase, establishing the start of the first period for detection operations.

The method for autonomous wildfire detection and suppression may include executing a fire extinguishing process that may be completed within a second period, wherein a duration of a sum of the first period and the second period does not exceed a defined value between fifteen and thirty minutes. As shown in FIG. 7, the second period may encompass the GFSC transit time phase, during which guided fire-suppression capsule launch and guidance operations may occur over a period of 5-20 minutes. The timeline may demonstrate the progression from detection through launch, transit, and terminal engagement phases to ensure rapid suppression response within the specified time constraints.

The executing of the fire extinguishing process may comprise launching by a given high-altitude unmanned aerial vehicle a guided fire-suppression capsule toward the ignition point. The launching phase may be initiated immediately following ignition detection and validation, with the given high-altitude unmanned aerial vehicle releasing a guided fire-suppression capsule from its payload bay or external hardpoints. The launch sequence may be coordinated through communication between the ground control station and the selected unmanned aerial vehicle to ensure proper targeting data transmission and deployment authorization.

The method may include selecting the given high-altitude unmanned aerial vehicle based on a proximity of the high-altitude unmanned aerial vehicles to the ignition point. The selection process may evaluate the geographic positions of multiple unmanned aerial vehicles within the fleet relative to the detected ignition coordinates to identify the unmanned aerial vehicle with the shortest flight distance to the target area. The proximity-based selection may minimize the transit time required for guided fire-suppression capsule delivery and may enable the system to achieve suppression within the specified timeline constraints.

The selecting may be executed by the high-altitude unmanned aerial vehicles through distributed decision-making algorithms that may enable autonomous coordination without requiring centralized ground control intervention. The unmanned aerial vehicles may communicate among themselves to share position data, ignition coordinates, and payload availability information to determine the most appropriate platform for guided fire-suppression capsule deployment. The distributed selection process may reduce communication latency and may enable faster response times compared to centralized decision-making approaches.

The selecting may be further based on an availability of guided fire-suppression capsules carried by each unmanned aerial vehicle in the fleet. The selection algorithm may consider both proximity to the ignition point and the number of available guided fire-suppression capsules remaining in each unmanned aerial vehicle's payload inventory. An unmanned aerial vehicle with closer proximity but depleted guided fire-suppression capsule inventory may be bypassed in favor of a more distant unmanned aerial vehicle that may carry sufficient suppressant payloads for effective fire suppression operations.

As further illustrated in FIG. 7, the executing may comprise autonomously delivering by the guided fire-suppression capsule a fire suppressant material to the ignition point during the terminal engagement phase. The autonomous delivery process may occur during the final phase of the timeline, where the suppressant may be dispersed over the target area in less than four minutes. The guided fire-suppression capsule may navigate autonomously using onboard sensors and guidance systems to achieve precise delivery of fire suppressant material directly to the ignition coordinates.

The system may deploy multiple guided fire-suppression capsules in sequence or salvo to build up suppressant coverage over an area surrounding the ignition point. Sequential deployment may involve launching guided fire-suppression capsules at timed intervals from the same unmanned aerial vehicle or from multiple unmanned aerial vehicles to provide layered suppressant coverage. The sequential approach may enable the system to address larger ignition areas or to provide redundant suppressant delivery to ensure complete fire extinguishment.

Salvo deployment may involve simultaneous or near-simultaneous release of multiple guided fire-suppression capsules from one or more unmanned aerial vehicles to create concentrated suppressant coverage over the target area. The salvo approach may be employed when initial fire size assessments indicate that a single guided fire-suppression capsule may not provide sufficient suppressant material for complete extinguishment. The multiple capsule deployment may create overlapping suppressant footprints that may ensure comprehensive coverage of the ignition area and surrounding zones where fire spread may be occurring.

The timeline progression shown in FIG. 7 may demonstrate the coordination between detection, launch, transit, and delivery phases to achieve rapid fire suppression within the specified 15-30 minute window. The guided fire-suppression capsule may be shown in flight during the transit phase, illustrating the autonomous navigation process from launch to target engagement. The airburst suppression event depicted on the right side of the timeline may represent the final delivery of suppressant material and the completion of the fire extinguishing process within the defined temporal constraints.

The method may coordinate multiple deployment cycles when fire conditions may require additional suppressant coverage beyond initial guided fire-suppression capsule delivery. The timeline framework may accommodate repeated deployment sequences wherein additional guided fire-suppression capsules may be launched following assessment of initial suppression effectiveness. The system may maintain the same temporal constraints for subsequent deployments to ensure continued rapid response capabilities throughout extended suppression operations.

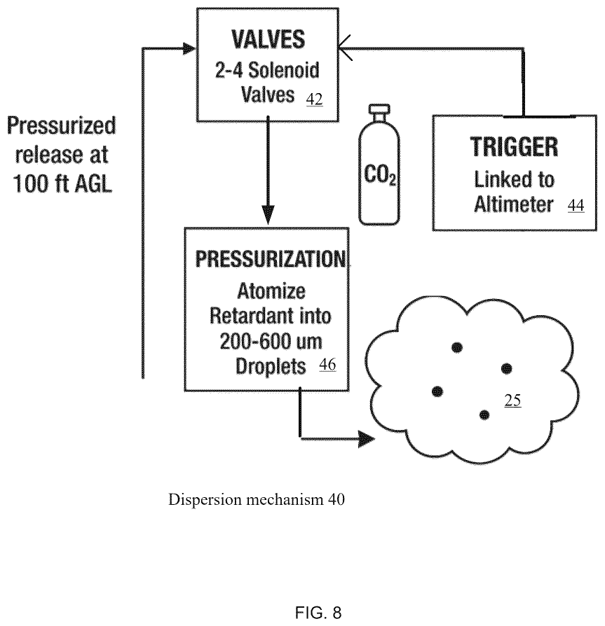

Referring to FIG. 8, a dispersion mechanism 40 for a guided fire-suppression capsule may enable controlled release of fire suppressant material at predetermined altitudes to achieve effective ground coverage patterns. The dispersion mechanism 40 may include a valves 42 that may include 2-4 solenoid valves (or any number of flow control units) that may receive input from a trigger 44 as illustrated in FIG. 8, with an optional mechanical fallback timer included as a redundant trigger where altitude sensing fails. A component linked to an altimeter for precise timing control of suppressant release operations. A CO₂ bottle may provide pressurization to the system, enabling atomization 46 of fire suppressant material 24 into controlled droplet 25 sizes for optimal dispersion characteristics.

The autonomously delivering may comprise releasing the fire suppressant material at an altitude above ground level determined based on measured wind speed conditions. The dispersion mechanism may adjust release altitude parameters based on real-time wind speed measurements to compensate for atmospheric effects on suppressant distribution patterns. For a measured wind that does not exceed ten kilometers per hour, the altitude may be about one hundred feet above ground level to enable effective suppressant coverage under low-wind conditions. For a measured wind that ranges between ten and forty kilometers per hour, the altitude may be about fifty feet above ground level to reduce wind drift effects during suppressant descent. For a measured wind that is above fifty kilometers per hour, the altitude may be about thirty feet above ground level to minimize lateral displacement of suppressant material during high-wind conditions.

The wind speed data may be based upon meteorological information and historical data that may be processed by the guidance system to determine appropriate release parameters for specific atmospheric conditions. The trigger component may receive wind speed measurements from onboard sensors or from external meteorological data sources transmitted to the guided fire-suppression capsule during flight operations. The altitude selection process may be executed automatically by the guidance system based on predetermined algorithms that may correlate wind speed measurements with optimal release altitudes for effective suppressant delivery.

As shown in FIG. 8, the releasing may be preceded by atomizing the fire suppressant material before the releasing through a pressurization stage that may process suppressant material from the valves component. The pressurization stage may atomize retardant into 200-600 micrometer droplets that may provide optimal size distribution for fire suppression effectiveness. The CO₂ cartridge system may provide the pressurization force needed to expel suppressant material through the solenoid valves and may enable controlled atomization of the suppressant into the desired droplet size range.

The dispersion mechanism may comprise solenoid valves and a pressurization system configured to atomize the fire suppressant material into droplets with specific size characteristics for enhanced suppression performance. The solenoid valves may be electronically controlled by the trigger component and may provide precise timing control for suppressant release operations. The pressurization system may include CO₂ cartridge systems that may generate sufficient pressure to expel suppressant material and may enable atomization processes that may break the suppressant into fine droplets suitable for fire suppression applications.

The pressurization stage may output suppressant material to a dispersion cloud, as depicted in FIG. 8, wherein the cloud-like formation may contain dispersed droplets distributed over the target area. The dispersion cloud may achieve a 30-50 meter diameter dispersion pattern that may provide comprehensive coverage of ignition areas and surrounding zones where fire spread may be occurring. The guided fire-suppression capsule may be configured to airburst at a selectable altitude above ground level to generate a suppression footprint exceeding a predetermined ground area based on operational requirements and fire conditions.

The system may achieve specific performance targets including 625 grams per square meter suppressant density over 2,000 square meter target areas through coordinated operation of the dispersion mechanism components. The combination of controlled release altitude, atomized droplet size, and pressurized dispersion may enable the guided fire-suppression capsule to deliver sufficient suppressant material to extinguish ignition areas effectively. The 30-50 meter diameter dispersion clouds may provide coverage areas that may exceed the typical size of initial wildfire ignitions and may create suppressant barriers that may prevent fire spread beyond the immediate ignition zone.

The autonomously navigating may be executed while the guided fire-suppression capsule descends at supersonic speed through atmospheric wind layers to minimize wind drift during descent. The supersonic descent velocity may enable the guided fire-suppression capsule to traverse high-wind atmospheric layers rapidly, reducing the time available for wind forces to deflect the capsule from its intended trajectory. The high-speed descent through atmospheric wind layers may maintain trajectory accuracy and may enable precise delivery of suppressant material to target coordinates despite adverse wind conditions.

The releasing may be executed at an altitude that ranges between thirty thousand and fifty thousand feet, corresponding to the operational altitude of the high-altitude unmanned aerial vehicles that may deploy the guided fire-suppression capsules. The high-altitude release may enable the guided fire-suppression capsules to achieve supersonic descent velocities and may provide sufficient flight time for guidance system operation and trajectory correction during the descent phase. The altitude range may position the release point above primary atmospheric turbulence layers, enabling stable deployment conditions and predictable initial trajectory characteristics.

The trigger component may include mechanical backup systems such as timer-based triggers in addition to altimeter-linked triggers to ensure reliable suppressant release under various operational conditions. The timer-based triggers may provide redundant release capability in scenarios where altimeter systems may malfunction or where atmospheric conditions may affect barometric pressure measurements. The mechanical backup systems may be pre-programmed with estimated flight times from release to target engagement, enabling suppressant release based on elapsed time calculations when primary altitude-based triggering may not be available.

The trigger component may receive feedback from the valves component to control the timing of pressurized release operations and may coordinate the sequence of pressurization, valve opening, and suppressant expulsion. The feedback system may enable the trigger component to monitor valve operation status and may provide confirmation of successful suppressant release to other guidance system components. The coordinated operation between the trigger component, valves component, and pressurization system may ensure reliable suppressant delivery and may enable the dispersion mechanism to achieve the specified performance targets for suppressant density and coverage area.

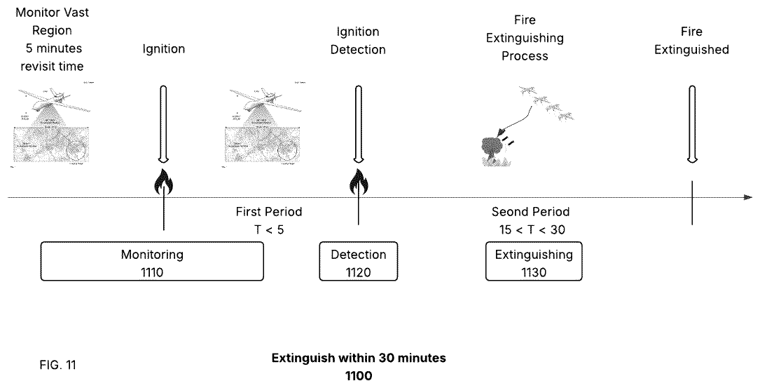

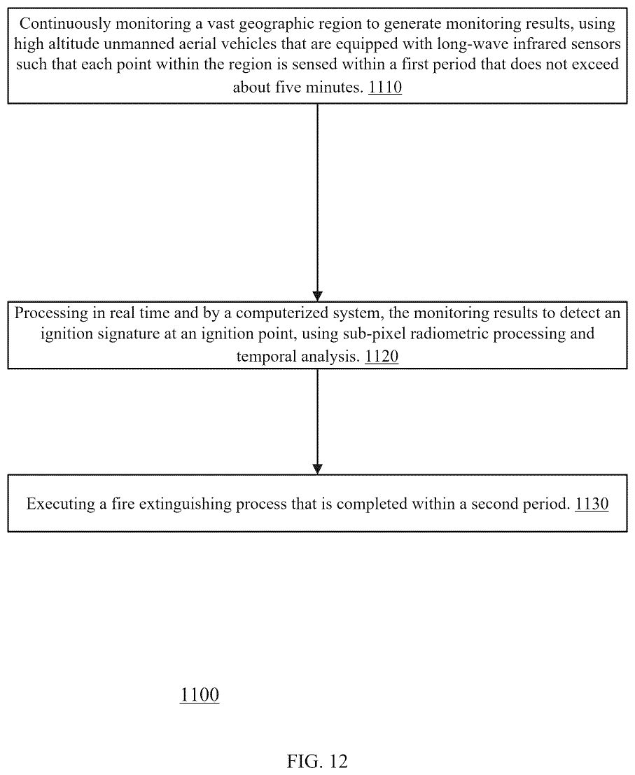

FIGS. 11-12 illustrate an example of method 1100 for autonomous wildfire detection and suppression.

Method 1100 may include step 1110 (denoted monitoring in FIG. 11) of continuously monitoring a vast geographic region to generate monitoring results, using high altitude unmanned aerial vehicles that are equipped with long-wave infrared sensors such that each point within the region is sensed within a first period that does not exceed about five minutes.

Method 1100 may also include step (denoted detection in FIG. 11) 1120 of processing in real time and by a computerized system, the monitoring results to detect an ignition signature at an ignition point, using sub-pixel radiometric processing and temporal analysis.

When finding, as a result of the processing, the ignition signature, step 1120 is followed by step 1130 (denoted extinguishing in FIG. 11) of executing a fire extinguishing process that is completed within a second period.

A duration of a sum of the first period and the second period does not exceed a defined value between fifteen and thirty minutes. The sum may be determined in any manner—for example based on an expected or predicted or measured rate of fire propagation in a different region and/or under weather conditions—for example having a strong wind within an environment full of combustible materials may require a faster response that having a weak wind within a environment that is not full of combustible materials.

According to an embodiment step 1130 includes (a) launching by a given high-altitude unmanned aerial vehicle, a guided fire-suppression capsule toward the ignition point; (b) autonomously navigating the guided fire-suppression capsule towards the ignition point; and (c) autonomously delivering, by the guided fire-suppression capsule, a fire suppressant material to the ignition point.

According to an embodiment, the autonomously navigating is executed while the guided fire-suppression capsule descends at supersonic speed through atmospheric wind layers to minimize wind drift during descent.

According to an embodiment, the autonomously delivering comprises releasing the fire suppressant material at an altitude above ground level determined based on measured wind speed conditions.

According to an embodiment, the releasing is preceded by atomizing the fire suppressant material before the releasing.

According to an embodiment, for a measured wind that does not exceed ten kilometers per hour, the altitude is about one hundred feet, wherein for a measured wind that ranges between ten and forty kilometers per hour the altitude is about fifty feet, and wherein for a measured wind that is above fifty kilometer per hour the altitude is about thirty feet.

According to an embodiment, the continuously monitoring is executed by the high altitude unmanned aerial vehicles while flying at an altitude that ranges between thirty thousand and fifty thousand feet.

According to an embodiment, the continuously monitoring is executed by the high altitude unmanned aerial vehicles while flying at a turbulence free air region.

According to an embodiment, the launching is executed at an altitude that ranges between thirty thousand and fifty thousand feet.

According to an embodiment, the executing includes selecting the given high-altitude unmanned aerial vehicle based on a proximity of the high-altitude unmanned aerial vehicles to the ignition point. For example—choosing the closest high-altitude unmanned aerial vehicle. Yet for another example—selecting the high-altitude unmanned aerial vehicle that is close enough and is headed towards the point of ignition.

According to an embodiment, the selecting is executed by the high-altitude unmanned aerial vehicles.

According to an embodiment, the selecting is further based on an availability of guided fire-suppression capsules. For example—selecting a high-altitude unmanned aerial vehicle that has more guided fire-suppression capsules than another high-altitude unmanned aerial vehicle—even if the former high-altitude unmanned aerial vehicle is a bit closer to the ignition location.

According to an embodiment, the method further includes receiving coordinates of the ignition point by the guided fire-suppression capsule, wherein the navigating is based on the coordinates and on infrared sensing of fire at the ignition point.

According to an embodiment, the coordinates are provided to the guided fire-suppression capsule by the given high-altitude unmanned aerial vehicle.

According to an embodiment, the method includes checking whether the fire extinguishing process succeeded and performing another fire extinguishing process when the fire extinguishing process succeeded failed.

According to an embodiment, the executing a fire extinguishing process is further conditioned by receiving a human approval.

A number of implementations have been described. Nevertheless, it will be understood that various modifications may be made without departing from the spirit and scope of the disclosure. Accordingly, other implementations are within the scope of the following claims.

1. A method for autonomous wildfire detection and suppression, comprising:
continuously monitoring a vast geographic region to generate monitoring results, using high altitude unmanned aerial vehicles that are equipped with long-wave infrared sensors such that each point within the region is sensed within an first period that does not exceed about five minutes;
processing in real time and by a computerized system, the monitoring results to detect an ignition signature at an ignition point, using sub-pixel radiometric processing and temporal analysis;
when finding the ignition signature, executing a fire extinguishing process that is completed within a second period, wherein a duration of a sum of the first period and the second period does not exceed a defined value between fifteen and thirty minutes;
wherein the executing comprises:
launching by a given high-altitude unmanned aerial vehicle, a guided fire-suppression capsule toward the ignition point;
autonomously navigating the guided fire-suppression capsule towards the ignition point; and
autonomously delivering, by the guided fire-suppression capsule, a fire suppressant material to the ignition point.

2. The method of claim 1, wherein the autonomously navigating is executed while the guided fire-suppression capsule descends at supersonic speed through atmospheric wind layers to minimize wind drift during descent.

3. The method of claim 1, wherein the autonomously delivering comprises releasing the fire suppressant material at an altitude above ground level determined based on measured wind speed conditions.

4. The method of claim 3, wherein the releasing is preceded by atomizing the fire suppressant material before the releasing.

5. The method according to claim 3, wherein for a measured wind that does not exceed ten kilometers per hour, the altitude is about one hundred feet, wherein for a measured wind that ranges between ten and forty kilometers per hour the altitude is about fifty feet, and wherein for a measured wind that is above fifty kilometer per hour the altitude is about thirty feet.

6. The method of claim 1, wherein the continuously monitoring is executed by the high altitude unmanned aerial vehicles while flying at an altitude that ranges between thirty thousand and fifty thousand feet.

7. The method of claim 1, wherein the continuously monitoring is executed by the high altitude unmanned aerial vehicles while flying at a turbulence free air region.

8. The method of claim 1, wherein the launching is executed at an altitude that ranges between thirty thousand and fifty thousand feet.

9. The method according to claim 1, wherein the executing comprises selecting the given high-altitude unmanned aerial vehicle based on a proximity of the high-altitude unmanned aerial vehicles to the ignition point.

10. The method according to claim 9 wherein the selecting is executed by the high-altitude unmanned aerial vehicles.

11. The method according to claim 9, wherein selecting is further based on an availability of guided fire-suppression capsules.

12. The method according to claim 1, further comprising receiving coordinates of the ignition point by the guided fire-suppression capsule, wherein the navigating is based on the coordinates and on infrared sensing of fire at the ignition point.

13. The method according to claim 12, wherein the coordinates are provided to the guided fire-suppression capsule by the given high-altitude unmanned aerial vehicle.

14. The method according to claim 1, further comprising checking whether the fire extinguishing process succeeded and performing another fire extinguishing process when the fire extinguishing process succeeded failed.

15. The method according to claim 1, wherein the executing a fire extinguishing process is further conditioned by receiving a human approval.

16. A guided fire-suppression capsule for autonomous wildfire suppression, comprising: an aerodynamic body configured for deployment from a high-altitude unmanned aerial vehicle; an infrared seeker positioned in a forward section of the body and configured to acquire thermal signatures of fires; a GPS/INS navigation module configured to provide positioning data during flight; flight-control electronics configured to process guidance signals; a suppressant reservoir containing fire suppressant material; and a dispersion mechanism configured to atomize and release the fire suppressant material at a predetermined altitude to achieve effective ground coverage, wherein the guided fire-suppression capsule is configured to autonomously navigate to a wildfire ignition point with high accuracy.

17. The guided fire-suppression capsule of claim 16, wherein the dispersion mechanism comprises solenoid valves and a pressurization system configured to atomize the fire suppressant material into droplets.

18. The guided fire-suppression capsule of claim 16, wherein the fire suppressant material comprises at least one material selected from the group consisting of ammonium phosphate, gel, foam, powder, water, liquid nitrogen, inert gases, carbon dioxide, and argon.
